(19) United States
(12) Patent Application Publication
(10) Pub. No.: US 2009/0199175 A1
(43) Pub. Date: Aug. 6, 2009

(54) Dynamic Allocation of Virtual Application Server

(75) Inventors: Bryan Keller, Snoqualmie, WA (US); Kenneth W. Revels, Woodinville, WA (US); Daniel Drew, Aliso Viejo, CA (US); Khuzaima Iqbal, Issaquah, WA (US); Alan C. Shi, Redmond, WA (US); Neil Jacobson, Arlington, MA (US); Eric Jewart, Waltham, MA (US); Gene Ferioli, Amesbury, MA (US); John Sheehan, Somerville, MA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/024,105

(22) Filed: Jan. 31, 2008

(51) Int. Cl. G06F 9/445

(52) U.S. Cl. 717/178

(57) ABSTRACT

A management system for virtual applications may deploy sets of virtual applications to many client devices, dynamically allocate virtual application servers to individual clients, manage updates to the virtual applications, and provide other high level management to deployments of virtual applications. A client device may include a virtual application management client that may communicate with a management server. The management client may add or remove virtual applications to the client device based on a policy received from the management server, and may query the management server to determine a currently available virtual application distribution server when a virtual application is requested. The management server may distribute and manage versions of applications across one or more virtual application distribution servers.

### BACKGROUND

Virtual applications are computer programs that may be executed in an application layer that is separate from the operating system layer. Virtual applications may enable an application to be executed on clients without being installed and to be administered from a central location.

Every application depends on its OS for a range of services, including memory allocation, device drivers, and much more. Incompatibilities between an application and its operating system can be addressed by either server virtualization or presentation virtualization. Application virtualization may address incompatibilities between two applications installed on the same instance of an operating system.

Applications installed on the same device commonly share configuration elements, yet this sharing can be problematic. For example, one application might require a specific version of a dynamic link library (DLL) to function, while another application on that system might require a different version of the same DLL. Installing both applications creates a situation where one of the applications may overwrite the version required by the other causing one of the applications to malfunction or crash. To avoid this, organizations often perform extensive compatibility testing before installing a new application, an approach that's workable but quite time-consuming and expensive.

Application virtualization may create application-specific copies of all shared resources. Each application may have a separate configuration of potentially shared resources such as registry entries, dynamic linked libraries, and other objects that may be packaged with the application. The package may be executed in a cache, creating a virtual application. When a virtual application is deployed, it uses its own copy of these shared resources.

A virtual application may be more easily deployed. Since a virtual application does not compete for dynamic linked library versions or other shared aspects of an application environment, compatibility testing may be reduced or eliminated. In many instances, some applications may be used in a virtual manner while other applications may be operated natively.

### SUMMARY

A management system for virtual applications may dynamically allocate a virtual application server when a client device requests a virtual application. A management server may receive requests from client devices requesting access to a virtual server. The management server may determine the best virtual server for the situation using various factors, including the current workload of the individual servers, network bandwidth, or other factors. The client device may route requests for a virtual application through a management connector that may communicate with the management server during the initial request for the virtual application. In some embodiments, the virtual application may use a streaming execution technique.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram illustration of an embodiment showing a system with managed virtual applications.

FIG. 2 is a diagram illustration of an embodiment showing functional components of system with dynamically allocated virtual applications.

FIG. 3 is a flowchart illustration of an embodiment showing a method for running virtual applications on a client.

FIG. 4 is a flowchart illustration of an embodiment showing a method for servicing clients.

### DETAILED DESCRIPTION

A virtual application management system may include a mechanism for dynamically allocating virtual application servers to a client. The mechanism may include a request from a client to a management server for a virtual application server, and the management server may determine an appropriate virtual application server for the situation and return an address for the virtual application server. The client may then initiate a virtual application session with the virtual application server.

The dynamic allocation of virtual application servers may be used in a multiple server situation to balance loads between servers and to optimize performance for both clients and servers. Such a technique may be particularly useful in large deployments of virtual applications, such as across a department, company, or other large enterprise. In some embodiments, virtual applications may be deployed across tens, hundreds, or thousands of client devices.

The management server may dynamically allocate different virtual application servers with each request from a client device to access a virtual application. In some cases, the management server may perform load balancing by connecting new requests with a virtual application server that is lightly loaded. In other cases, the management server may allocate requests to specific virtual application servers based on network proximity, availability of specific virtual applications, availability of updated virtual applications, or for other reasons.

In one use scenario, a device may be configured to use a virtual application and cache the downloaded portions of the virtual applications. The cache may not contain the entire virtual application, but when a portion is requested that is not in the cache, a management server may direct a client to an appropriate server from which the portion may be retrieved.

In an example, a user may use a portion of a virtual application using a laptop computer in the office. At the office, the user may connect with a local virtual application server as directed by a management server. When the user boards a plane and travels to another company location, the management server may detect the user's location and direct the laptop to connect to a different virtual application server. The second virtual application server may be a local server in this case.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

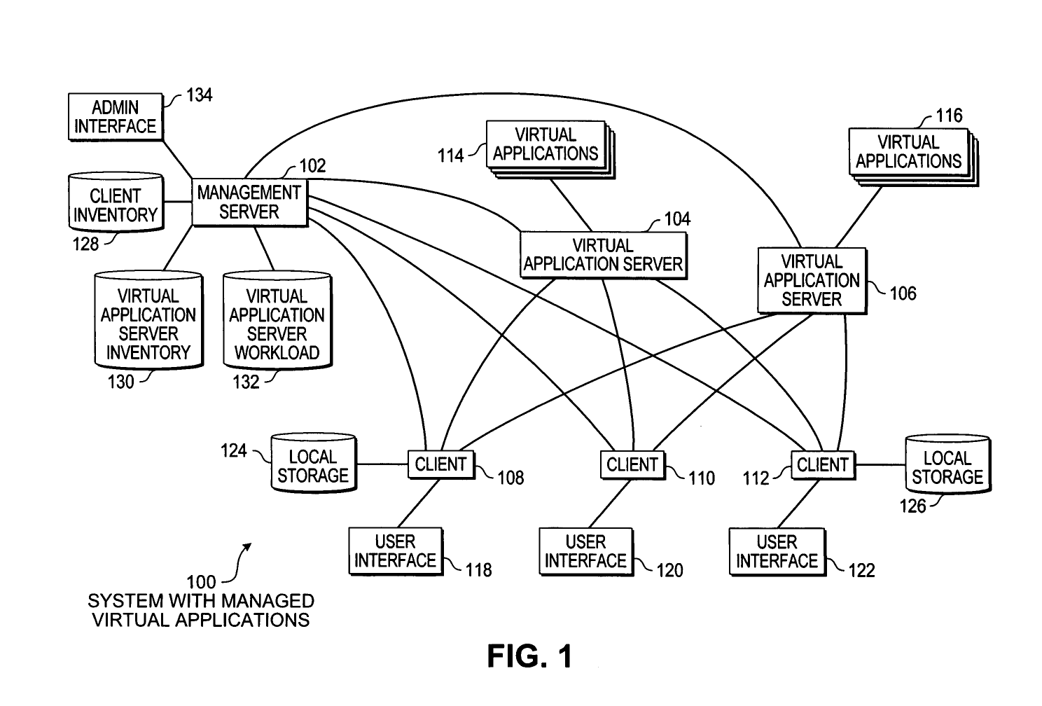

FIG. 1 is a diagram of an embodiment 100 showing a system with managed virtual applications. Embodiment 100 is a simplified example of a virtual application management system that may manage virtual applications across many client devices by allocating virtual servers to clients based on a client request for a virtual application.

The diagram of FIG. 1 illustrates functional components of a system. In some cases, the component may be a hardware component, a software component, or a combination of hardware and software. Some of the components may be application level software, while other components may be operating system level components. In some cases, the connection of one component to another may be a close connection where two or more components are operating on a single hardware platform. In other cases, the connections may be made over network connections spanning long distances. Each embodiment may use different hardware, software, and interconnection architectures to achieve the functions described.

Embodiment 100 is an example of a system with managed virtual applications. The management server 102 may provide several functions to manage the overall interactions between several virtual application servers 104 and 106 and several client devices 108, 110, and 112. The virtual application servers 104 and 106 may provide one or more virtual applications 114 and 116, respectively, to the clients.

The management server 102 may coordinate the connections between the clients and servers by assigning a server to a client at the time the client requests a virtual application. The management server 102 may be able to determine which virtual application server may be better suited to service the request based on the loading of the virtual application server, the current bandwidth of the network, processor, storage, or other component, or on other factors.

The clients 108, 110, and 112 may each have a user interface 118, 120, and 122, respectively through which a virtual application may be requested. In a typical use scenario, a user may select an icon from a graphical user interface to initiate a virtual application. In other scenarios, a user may enter a command line command, select a menu item, or perform some other action to initiate a virtual application. In some embodiments, a virtual application may be called by another application or service without any user interaction.

Virtual applications have several capabilities that differentiate virtual applications from conventional applications. Virtual applications may be ‘packaged’ with registries, dynamic linked libraries (DLLs), and other components of an application. The virtual application may be executed in a manner that does not interfere with other applications, services, or executables on a client device. Virtual applications may be executed in a virtual environment that separates the application layer from the operating system layer in a computing platform.

In a conventional or non-virtual application, many components such as registry entries, DLLs, and other components are installed within other similar components in an operating system. An example of a problem may occur when two applications share the same DLL, but one application gets upgraded and may expect one version of the DLL while the other application may operate with an older version of the same DLL.

Because conventional applications interface with operating system components, conventional applications generally undergo a complex install and uninstall process. In cases where an application has a shared component such as a shared DLL, an uninstall process may leave the DLL so as not to cause a problem with another application.

Virtual applications may generally be added and removed without a complex install or uninstall process. Virtual applications may be added or removed by adding or removing the unitized virtual application package from a client device.

Virtual applications may be supplied from a server in different forms. In one type of deployment, a virtual application may be streamed from a virtual application server. In a streaming deployment, a client may request a virtual application from a virtual application server which may begin transmitting portions of the virtual application that may be executed directly. A streaming virtual application may begin execution on the client device with a portion of the executable instructions and, in some cases, without having the entire virtual application downloaded to the client. Streaming techniques may enable a virtual application to start execution quickly. In many such deployments where there is available network bandwidth and a responsive virtual application server, a user experience may rival a locally stored and executed application.

Some streaming deployments may enable an application to be executed on a client device by transferring executable instructions from a virtual application server to random access memory (RAM) on the client device without storing the executable instructions on a persistent storage device such as a hard disk.

Other deployments may use a local copy of a virtual application that may be stored on a hard disk or other storage device local to the client. The local copy of the virtual application may be downloaded from a virtual application server prior to use.

Some embodiments may use a combination of streaming technologies with a local copy of a virtual application. Such an embodiment may use various streaming techniques to begin downloading and executing a virtual application on a client device and may further store the downloaded virtual application on a local storage device for a second or subsequent use. Many such embodiments may enable a client device to being execution quickly with the initial portions of the download and may continue to download remaining portions of the virtual application as bandwidth permits so that the client device may eventually contain the entire virtual application locally. When the application is available locally, the application may sometimes execute faster.

Streaming deployments have a capability that may enable an application to be upgraded on the virtual application server without having to upgrade or change the client device. Such a capability may ease licensing, managing, monitoring, and other administrative tasks.

Streaming deployments, and to a lesser degree downloading-type deployments may use a considerable amount of bandwidth in some instances. In many cases, a streaming deployment may use bursts of processing, disk, and network bandwidth from both the server and client. The ability of the server and network to respond to the bursts of activity may affect the user experience. If there is a limited network bandwidth or the server processor or disk is busy at the time a portion of a virtual application is requested, the user may experience a lag time or delay.

When a virtual application is downloaded and run locally on a client, some embodiments may enable a small portion of the virtual application to be downloaded quickly so that execution may begin. This action may use a large amount of initial bandwidth. As the application is being used, other portions of the virtual application may be quickly downloaded on an as-requested basis using large amounts of bandwidth, and other portions may be downloaded as a slower background process with less bandwidth.

Some deployments may use a local cache that may have features of a streaming deployment and a download deployment. Such a deployment may be a streaming deployment where a local cache is used to store the portions of the application that have been previously downloaded. Such an embodiment may download those portions of the application that are requested, but store the download for quick restarting the virtual application.

When a virtual application is downloaded and stored on a client, the second and subsequent uses of the virtual application may use the locally stored copy. Some clients, such as clients 108 and 112 may have local storage 124 and 126, respectively, that may be used for such purposes. A client may perform an initial query to the management server 202 to determine if the local copy is a current copy. If the local copy is current, the client may begin execution using the locally stored virtual application. If the local copy is not current, the client may begin execution using a streaming mechanism and may download and overwrite the older version. In some cases, various techniques such as Binary Data Replication or Remote Differential Compression may be used to perform an update of the local version of a virtual application.

The management server 102 may allocate virtual application servers 104 and 106 based on the relative capacity of each of the servers to respond to an immediate request for a virtual application. The management server 102 may use a client inventory 128, a virtual application server inventory 130, and a virtual application server workload 132 to determine an optimized server to handle an incoming request.

The client inventory 128 may include information about a client that may be used to determine an appropriate virtual application server for a request. Such information may include configuration information about the client, such as which virtual applications are permitted for the client, connection settings, as well as execution and other configuration settings. An example of an execution or configuration setting may be whether the virtual application is stored locally or streamed from a server.

The client inventory 128 may include current or historical performance data for the client/server connection. For example, overall performance of a client/server combination may be tracked to identify those combinations that have better network performance. In another example, a client or server may issue a ping command or other network performance measurement to estimate network capabilities prior to establishing a connection. Such performance data may be communicated to the management server 102 for use when determining an optimized client/server combination.

The virtual application server inventory 130 may include metadata describing which virtual applications are available on which virtual application server. In many cases, the versions of each virtual application and the capabilities of each virtual application server may be stored in the virtual application server inventory 130 to match a client request with a set of virtual application servers.

The virtual application server workload 132 may contain historical and present performance data that may be used to determine an optimized client/server combination in response to a request. In some embodiments, one or more current performance parameters may be monitored and stored in the virtual application server workload 132 so that the management server 102 may allocate virtual application requests to balance loads across virtual application servers and optimize a user's experience.

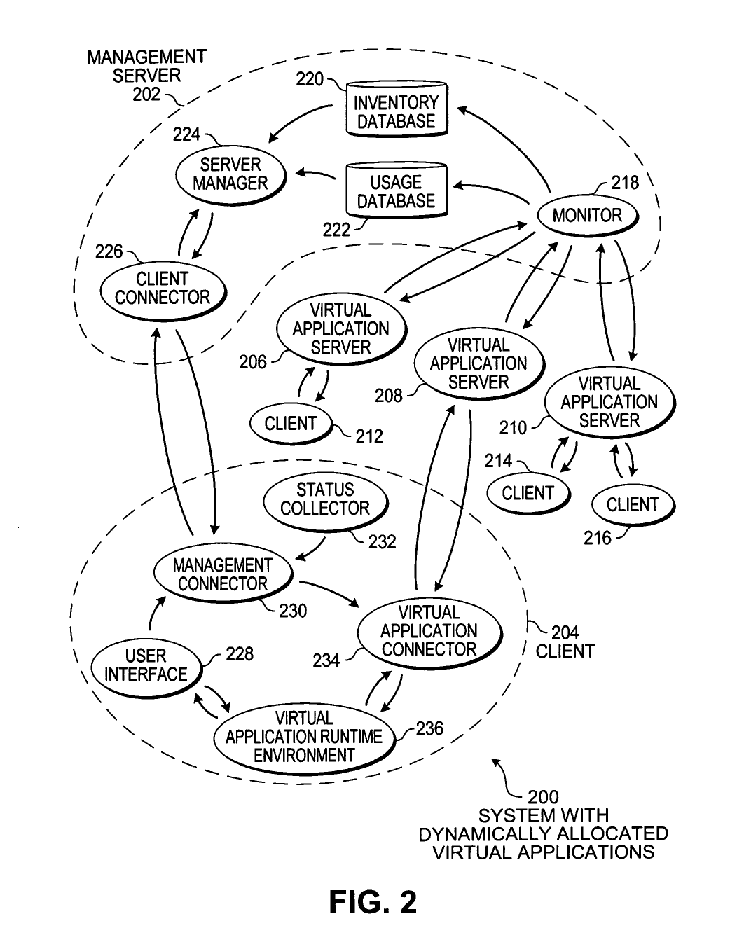

FIG. 2 is a functional diagram illustration of an embodiment 200 that is an example of a functional representation of a system with dynamically allocated virtual applications. Embodiment 200 illustrates the functional components that may make up an embodiment that allocates virtual application servers to individual requests from a client.

The diagram of FIG. 2 illustrates functional components of a system. In some cases, the component may be a hardware component, a software component, or a combination of hardware and software. Some of the components may be application level software, while other components may be operating system level components. In some cases, the connection of one component to another may be a close connection where two or more components are operating on a single hardware platform. In other cases, the connections may be made over network connections spanning long distances. Each embodiment may use different hardware, software, and interconnection architectures to achieve the functions described.

Embodiment 200 illustrates a management server 202 that may interact with a client 204 to initiate a virtual application session with any of the virtual application servers 206, 208, or 210. When a virtual application is to be executed on the client 204, the client 204 may communicate with the management server 202 to receive an address or other indicator for one of the virtual application servers 206, 208, or 210. The client 204 may then initiate a session with the selected virtual application server and begin downloading and executing a virtual application.

The management server 202 may manage client requests for virtual applications across many virtual application servers and many clients. The management server 202 may allocate virtual application server resources across client requests using, among other things, the current usage, bandwidth, or workload of each virtual application server. In some cases, the management server 202 may also use network bandwidth or other parameters as well.

The system of embodiment 200 illustrates a situation where a client 212 may have a virtual application session with virtual application server 206 and clients 214 and 216 may each have a session with virtual application server 210.

In many cases, a virtual application session may exist for extended periods of time. For example, a user on a client device may establish a streaming virtual application session and the user may keep the virtual application open and executing for several hours, overnight, or even for days and weeks. The session may include periodic communication between the client and virtual application server, but the bandwidth and resource usage may be minimal. In such a situation, the addition of a new session with a new client may have minimal adverse effects on the performance of either session.

In some cases, several client devices may initiate sessions around the same time. Some virtual applications may use a large amount of virtual application server resources during the initial period of use, and when several clients requests a virtual application during a period of high resource usage, the management server 202 may spread such client requests across different virtual application servers.

The management server 202 may have a monitor 218 that may periodically monitor the performance and inventory of the various virtual application servers 206, 208, and 210. In some embodiments, the monitor 218 may query the virtual application servers directly, while in other embodiments the monitor 218 may query a performance monitoring service that may collect such data.

The monitor 218 may collect various inventory data from each virtual application server and store the inventory data in an inventory database 220. The inventory database may include the particular virtual applications available to be served by each virtual application server, the configuration of the virtual applications, the manners in which the virtual applications may be transmitted, and other parameters.

In some embodiments, the inventory database 220 may include physical locations or network locations of the virtual application servers. Such information may be used to match clients and servers that are in close physical or network proximity.

The monitor 218 may collect various performance data for each virtual application server and store the performance data in a usage database 222. The performance data may be such information as the number of existing sessions with clients, the status of each session and the history of resource loading for the sessions. The performance data may also include the processor usage, disk usage, memory usage, and network usage of the server. In some cases, the network usage may be measured by pinging a typical client device, measuring transmission times for existing sessions with clients, or some other mechanism.

The server manager 224 may determine an optimized virtual application server for requests that are received on a client connector 226.

The client connection 226 may be a service or function that receives requests from a client 204 and transmits information back to the client 204 such as an address or identifier for a specific virtual application server.

The server manager 224 may receive a request for a virtual application manager. The request may include an identifier for the requesting client, an indicator for the requested virtual application, and any special parameters or options requested by the client. In some embodiments, the client may send some performance data such as available network bandwidth or other data.

The server manager 224 may determine an optimized pairing of the client and a virtual application server for the particular situation. Many different embodiments may use different logic, calculations, priorities, or mechanisms to select a virtual application server for a particular situation. Each embodiment may use various factors and combine the factors to determine an appropriate virtual application server for a request.

In some embodiments, a client 204 may have a status collector 232 that may collect performance data and pass the performance data through a management connector 230 to the management server 202. The performance data may include network bandwidth, available space on a storage device, processor utilization, or other performance data from the client 204.

The management connector 230 may be the functional interface between the client 204 and the client connector 226 of the management server 202. The management connector 230 may generate requests for a virtual application server by receiving input from a user interface 228 or though an application's request to initiate a virtual application. The management connector 230 may transmit the request to the management server 202 and receive an address or other indicator for the virtual application server 208.

The address or indicator may be used by a virtual application connector 234 to establish a connection with the virtual application server 208 and begin receiving at least a portion of the virtual application. The virtual application may be executed in the virtual application runtime environment 236. In many cases, a user may interact with the virtual application using the user interface 228.

The management connector 230 may receive a network address, machine name, or some other designator that may be used by the virtual application connector 234 to establish a connection and begin receiving the virtual application.

The virtual application connector 234 may establish a connection with a virtual application server 208 using the designator received through the management connector 230 from the management server 204. The virtual application connector 234 may initiate a connection with the virtual management server 208 in many cases, and may perform authentication or other activities that may establish a session. The virtual application connector 234 may perform handshaking or other communication related activities, and pass the received portions of the virtual application to the virtual application runtime environment 236.

In some embodiments, a virtual application may be saved on a local cache 235 attached to the client device 204 when portions are downloaded from the virtual application server 208. In such cases, the virtual application connector 234 may store the downloaded data. In both streaming and downloading distributions of the virtual application may employ the local cache 235 to store portions of the virtual application locally. In some embodiments, contents of the local cache 235 may be loaded and executed for both downloaded and streaming distributions of a virtual application.

In many virtual application systems, portions of the virtual application may be downloaded and executed as those portions are requested by a user. In an example of a virtual word processing application, the initial downloaded portion of the word processing application may display a document and enable editing of the document. The downloaded portion of the application may be stored in the local cache 235, which may contain only portions of the virtual application. Some portions, such as spell checking or table formatting may not be downloaded until a spell checking or table formatting function is called. When a user selects spell checking, for example, the spell check portion of the word processing application may be retrieved from the virtual application server 208, executed, and stored in the local cache 235. In such embodiments, the virtual application runtime environment 236 and the virtual application connector 234 may communicate back and forth several times while the virtual application is executing.

In some embodiments, the client 204 may request metadata about the virtual application servers from the management server 202 in order to select an appropriate virtual application server. In such an embodiment, the management connector 230 may perform some of the functions described above for the server manager 224, such as evaluating metadata that may be in the inventory database 220 or the usage database 222 to determine which virtual application server to contact.

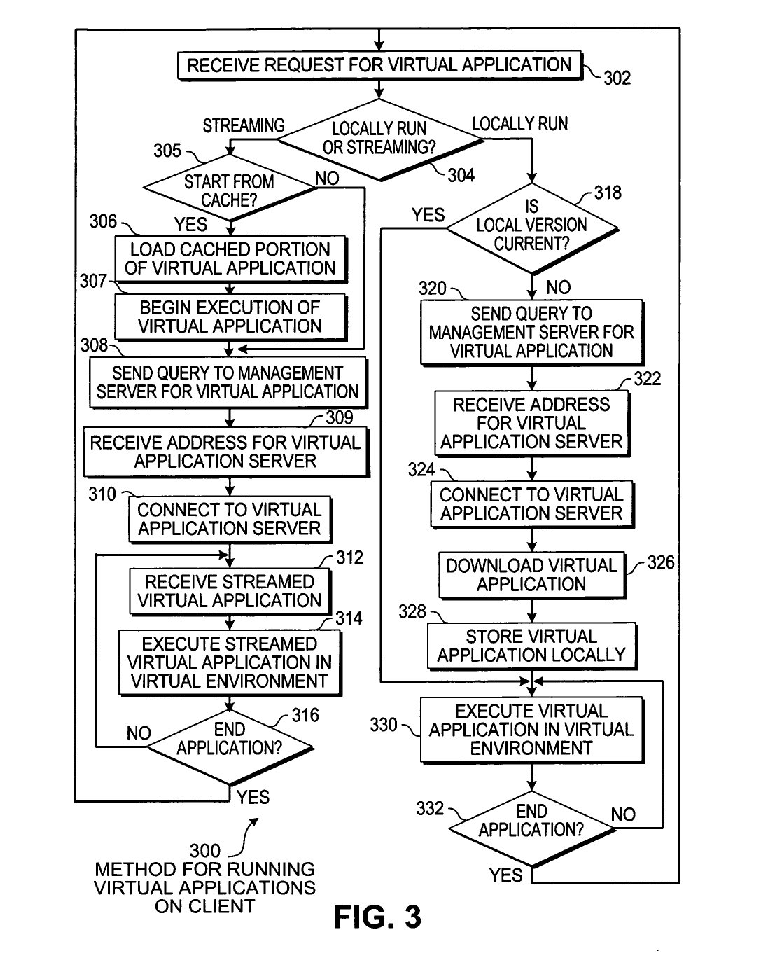

FIG. 3 is a flowchart illustration of an embodiment 300 showing a method for running virtual applications on a client. Embodiment 300 is an example of a sequence of functions that may be performed by a client.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 300 illustrates two sequences: one for a streaming virtual application execution and one for a downloaded or locally executed virtual application. In both sequences, a query to a management server may be used to select an appropriate virtual application server with which a connection may be established and the virtual application obtained.

Embodiment 300 illustrates various functional operations that may be performed. In some cases, such functions may be performed by one or more of the functional components described in embodiments 100 and 200.

A request may be received for a virtual application in block 302. The request for a virtual application may come from a user interface or from an application or service on the client device. An example of a user interface request may be a user selection of a desktop icon or a start menu item. Such a selection may launch a sequence to obtain and execute a virtual application.

The virtual application may be executed in a streaming manner or run from a locally stored version. In many cases, the virtual application may be configured to operate in one or the other modes.

If the virtual application is to be executed in a streaming manner in block 304, and a local cache has a portion of the virtual application that may be used to begin execution in block 305, that portion may be loaded from the cache in block 306. The portion may be executed in block 307. In block 305, if the cache is empty or for some reason contains unusable data, such as having an older version, a query may be sent to a management server in block 306. The query may include a designator or identifier for the desired virtual application, and may include various parameters, configuration items, or other information about the virtual application. In some cases, the query may include performance data, such as network bandwidth or other data.

After sending the request in block 306, an address or other identifier for a virtual application server may be received in block 308. The address or identifier may be any identifier by which the virtual application server may be identified and a communication session established.

A connection may be made to the virtual application server in block 310, and at least a portion of the streamed virtual application may be received in block 312 and executed in block 314. If the application is still executing in block 316, the process may return to block 312 where additional portions of the virtual application may be received and executed in block 314.

If the virtual application is terminated in block 316, the process may return to block 302.

If the virtual application is to be locally run in block 304, a query may be made to determine if the locally stored version of the virtual application is a current version in block 318. In some embodiments, a query may be made to the management server to determine a latest version of the virtual application and the latest version may be compared to the local version to determine if a newer version exists.

If the local version is not the current version in block 318, a query may be sent to the management server for a virtual application in block 320. An address or other identifier may be received from the management server in block 322 for the virtual application server. A connection to the virtual application server may be made in block 324 and the virtual application may be downloaded in block 326 and stored locally in block 328. The virtual application may be executed in a virtual environment in block 330.

In some embodiments, a portion of the virtual application may be downloaded, stored, and execution may begin before the entire virtual application may be downloaded.

Some embodiments may use various techniques such as Binary Data Replication or Remote Differential Compression to download updates to a local version of a virtual application. Such techniques may be able to reduce the amount of data that may be downloaded to update an older version to a current version.

If the local version is the current version in block 318, the virtual application may be executed in block 330 using a virtual environment or other virtualization mechanism.

When the application ends in block 332, the process may return to block 302, otherwise the process may continue in block 330 with the execution of the virtual application.

In many embodiments, a client device may operate several virtual applications. In some cases, one or more of the virtual applications may be locally run applications while others may be streaming. In some embodiments, a user may be able to select between a locally run or streaming virtual application.

When a client device operates two or more virtual applications simultaneously, a management server may assign the same virtual application server or different virtual application servers to the client. In some cases where the virtual applications are typically used in parallel by a client device, different virtual application servers may be used. In cases where the virtual applications are typically used separately or one at a time, two or more virtual applications may be served from the same server.

In some cases, the virtual application servers may be configured to server many different virtual applications, while in other cases, different virtual servers may be configured to serve one virtual application or a limited set of virtual applications.

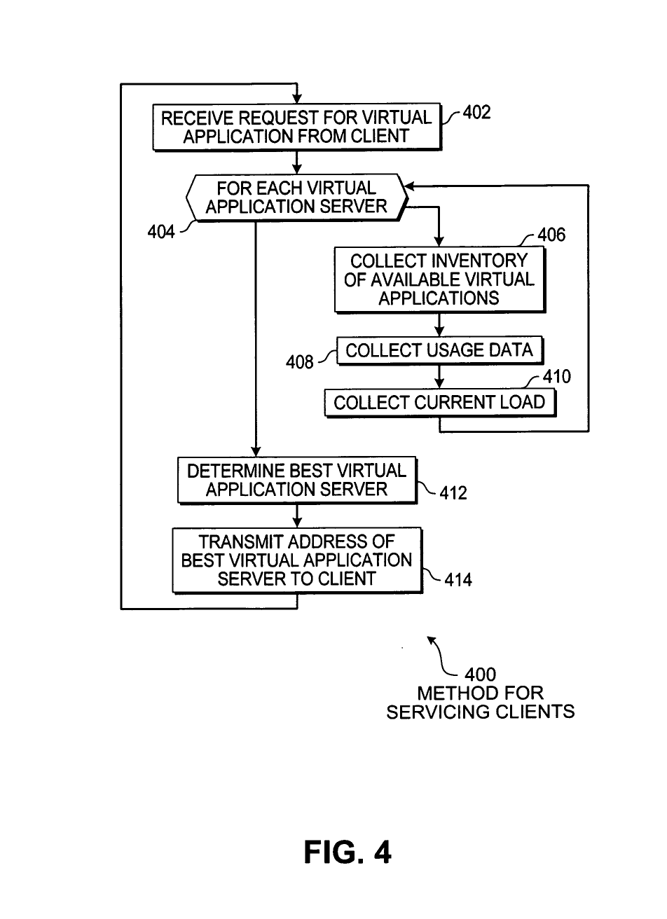

FIG. 4 is a flowchart illustration of an embodiment 400 showing a method for servicing clients as may be performed by a management server.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 400 is an example of a method for handling incoming requests from client devices for a virtual application server. A request may be received from a client for a virtual application in block 402. The request may contain an indicator for a virtual application as well as any parameters, options, or limitations on the virtual application.

A management server may manage several virtual application servers. For each of those servers in block 404, information may be collected in blocks 406, 408, and 410 about the virtual application server's capabilities and performance in order to determine an optimal virtual application server to handle the request.

In block 406, an inventory of available virtual applications may be taken. The inventory may include the virtual applications present on the virtual application server, as well as the versions, parameters, options, capabilities or other features that may be requested by a client.

Usage data may be collected in block 408. Usage data may include historical data that may include performance history and other prior usage of the server.

Current loading data may be collected in block 410. The current load data may include how many virtual application sessions are being supported on the server, the bandwidth being used currently, the processor, disk, and memory usage of the server, and other factors that may be used to describe how much capability of the server is used.

After collecting the data in block 404, the best virtual application server for the request may be determined in block 412. Each embodiment may use different mechanisms, formulas, weighting schemes, logic, calculations, or other factors to determine an optimum or best virtual application server for the request.

In some embodiments, a group of virtual application servers may be identified that have the capability to service the virtual application request, then the servers within that group may be analyzed to determine an appropriate server. Some embodiments may use one or more factors that may relate to the current workload of a virtual application server to sort, organize, or select a suitable virtual application server.

Some embodiments may determine the network or physical location of the requesting client device and attempt to match the client device with a virtual application server that is located near the client. Such an embodiment may attempt to limit any network delays that may occur due to the distance between the client and virtual application server.

When a suitable server is determined in block 412, the address of the selected virtual application server may be transmitted to the requesting client in block 414. In some embodiments, the address may be an Internet Protocol (IP) address, a machine name, a uniform resource locator (URL), or any other mechanism by which a virtual application server may be identified.

In some cases, a lookup table of virtual application servers may be present on a client device and may contain addresses corresponding to an index, and in such a case the management server may transmit the index to the requesting client without having to transmit an address or other complex syntax.

Embodiment 400 illustrates a sequential method for determining a virtual application server. In other embodiments, an asynchronous process may perform some or all of the steps 404, 406, 408, and 410. In some such embodiments, real time or near real time loading information in block 410 may be kept up to date by periodically polling the virtual application servers or by monitoring a service that tracks real time performance.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A method comprising:
receiving a first request for a virtual application;
determining if a first portion of said virtual application is in a local cache;
executing said first portion of said virtual application;
connecting to a first virtual application server;
receiving a second portion of said virtual application; and
executing said second portion of said virtual application.

2. The method of claim 1, said first portion being obtained from a second virtual application server.

3. The method of claim 1, said second portion of said virtual application being obtained by streaming.

4. The method of claim 1, said first portion of said virtual application being obtained by a downloading mechanism.

5. The method of claim 1, said second portion being received in response to a request for said second portion.

6. The method of claim 1 further comprising:
receiving metadata concerning a plurality of virtual applications; and
selecting said first virtual application based on said metadata.

7. The method of claim 6, said selecting being based at least in part on a first proximity to said first virtual application server.

8. The method of claim 6, said selecting being based at least in part on a performance parameter.

9. The method of claim 8, said performance parameter being network bandwidth.

10. A client device comprising:
a management connector configured to send a request to a management server for a virtual application server, said request comprising an indicator for a first virtual application, said management connector further configured to receive an address for said virtual application server;
a virtual application connector configured to use said address for said virtual application server to establish a connection to said virtual application server and download at least a portion of said first virtual application; and
a virtual application runtime environment configured to execute said portion of said first virtual application in a virtual manner.

11. The client device of claim 10, said request further comprising at least one configuration parameter.

12. The client device of claim 11, said configuration parameter comprising an indicator that said first virtual application is to be streamed from said virtual server.

13. The client device of claim 10, said request further comprising at least one performance parameter.

14. The client device of claim 13, said performance parameter comprising available network bandwidth.

15. A management server device comprising:
a client connector configured to receive a request for a virtual application server from a client device; and
a server manager configured to select one of a plurality of virtual application servers in response to said request;
said client connector further configured to transmit an address for said one of said plurality of virtual application servers to said client device.

16. The management server device of claim 15, said request comprising at least one performance parameter relating to said client device.

17. The management server device of claim 15 further comprising:
a monitor configured to communicate with said plurality of virtual application servers and collect status information from each of said plurality of virtual application servers.

18. The management server device of claim 17, said status information comprising an inventory of virtual applications.

19. The management server device of claim 17, said status information comprising performance parameters from at least one of said plurality of virtual application servers.

20. The management server device of claim 15, said server manager further configured to perform an optimization calculation to select said one of said plurality of virtual servers.
